(19) United States
(12) Patent Application Publication
(10) Pub. No.: US 2007/0003919 A1
(43) Pub. Date: Jan. 4, 2007

(54) Method, system and software for automated student information management

(75) Inventors: Stuart Stevenson, Plano, TX (US); Kearn Lacey, Dallas, TX (US); Danny Navarro, Round Rock, TX (US)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: Aprende Technology, Inc., Austin, TX (US)

(21) Appl. No.: 11/171,942

(22) Filed: Jun. 30, 2005

(51) Int. Cl. G09B 3/00

(52) U.S. Cl. 434/350

(57) ABSTRACT

A method, system and software are provided for automatically generating data entry forms customized for a particular school to satisfy university, conference and national compliance policies for student athletes. The form are provided electronically and the information entered into the forms by each student athlete is stored in a database. An administrator, coach, or other school official may then access appropriate data forms for each student athlete so that compliance with various scholastic or organizational requirements can be monitored and managed.

### TECHNICAL FIELD

This disclosure relates generally to maintaining a database and presenting information maintained in the database, and more particularly to presenting automatically generated forms for managing student information.

### APPENDED CODE

This application includes a computer program listing appendix on a single compact disk that includes a form template according to an embodiment of the present disclosure.

### BACKGROUND

Educational institutions face the daunting task of collecting information from thousands of students, and keeping that information current. From basic contact information such as a student's current address and telephone number, to more detailed information like that required to verify eligibility for financial aid, educational institutions must often commit huge amounts of money and personnel resources to gathering and maintaining information from students.

Gathering student information is traditionally done using paper forms filled out by each student prior to or during registration. Using paper forms, however, does not provided a convenient way to update information that changes over time. If a student moves to a new residence, for example, the student must find and complete appropriate change of address forms. Since this may require some time and effort and given the demands placed on students, students may delay updating their information or simply decline to fill them out if the task is deemed unimportant.

More recently, universities and other educational institutions have implemented web sites that allow students to provide some limited types of information, e.g. address, phone number, and the like, to their schools via the Internet. While these web sites address some of the problems associated with paper forms, they introduce a new set of issues related to web site design and maintenance. Initial implementation of the school's web site, for example, usually requires a programmer with advanced knowledge of web-site related programming languages such as hyper-text markup language (HTML), extensible markup language (XML), or the like. Advanced programming knowledge may also be required if the web site is changed to collect different information, or if changes are made to an existing web-site data-entry form.

Additional issues related to collecting information from students arise in the context of student athletes. Generally, universities must collect even greater amounts of information from student athletes than from other students to maintain information to satisfy university, conference and NCAA policies. Compliance information and forms, for example, must be completed to ensure that the student athletes maintain eligibility to participate in their sport. Making sure that these forms are completed, and tracking compliance of each student athlete with the particular requirements of that student athlete's sport can be extremely labor intensive and consume significant time and resources.

Consider, for example that a large university may have up to 1,000 student athletes participating in 20 or more different sports, each with different eligibility and/or reporting requirements. Of these, half may be receiving scholarships that have additional reporting and/or maintenance requirements. It is easy to imagine the administrative effort required to obtain all of this information and keep it current using only conventionally available web sites and physical forms.

### SUMMARY

Therefore a need has arisen for a system and method for acquiring and organizing information specific to student athletes.

In accordance with teachings of the present disclosure, a method, system and software are described for managing information associated with student athletes. In one form, data entry forms customized for a particular school to satisfy university, conference and national compliance policies for each student athlete are presented to respective student athletes via the Internet, an intranet, or other network. The information entered into the forms by each student athlete is stored in a database. An administrator, coach, or other school official can access appropriate data forms for each student athlete so that compliance with various scholastic or organizational requirements can be monitored.

In one aspect a method is disclosed including maintaining an information database including compliance information associated with multiple student athletes. The method also includes maintaining a forms database including form definitions customized for compliance with policies of an educational institution, an athletic conference and a national collegiate athletic organization. A first form associated with a selected student athlete is generated that is customized for compliance with policies of the educational institution using a forms template and one or more form definitions obtained from the forms database. A second form associated with the student athlete is generated and customized for compliance with policies of the athletic conference using the forms template and one or more form definitions obtained from the forms database. A third form associated with the selected student athlete is generated and customized for compliance with policies of the national collegiate athletic organization and one or more form definitions obtained from the forms database. The method further includes presenting the form to a user via a networked information handling system.

In another aspect, a computer readable medium tangibly embodying a program of executable instructions, said program of instructions is disclosed. The program includes one or more instructions executable to maintain an information database including information associated with multiple student athletes and one or more instructions executable to maintain a forms database including form definitions customized for a selected educational institution. The program also includes one or more instructions executable to automatically generate a first form associated with a selected student athlete and customized for compliance with policies of the selected educational institution using a forms template and one or more form definitions obtained from the forms database and one or more instructions executable to automatically generate a second form associated with the selected student athlete and customized for compliance with policies of the selected athletic conference using the forms template and one or more form definitions obtained from the forms database. Additionally, the program includes one or more instructions executable to automatically generate a third form associated with the selected student athlete and customized for compliance with policies of the selected national collegiate athletic organization and one or more form definitions obtained from the forms database and one or more instructions executable to present the forms to a user via a networked information handling system.

In another aspect, a system is disclosed including a processor and a memory. The memory may store an information database including information associated with multiple student athletes and a forms database including form definitions customized for compliance with policies of an educational institution, an athletic conference and a national collegiate athletic organization. The memory also stores a forms template. The system includes a communications subsystem for connecting the system to a communications network and a program of instructions for: generating a first form associated with a selected student athlete and customized for compliance with policies of the educational institution, generating a second form associated with the selected student athlete and customized for compliance with policies of the athletic conference, and generating a third form associated with the selected student athlete and customized for compliance with policies of the national collegiate athletic organization. The instruction may also present the forms to a user via a remote information handling system coupled to the information handling system via the communications subsystem.

The present disclosure includes a number of important technical advantages. For example, automatically generating forms specific to university, athletic conference and national compliance policies allows the system to advantageously acquire student athlete compliance information. Additional advantages will be apparent to those of skill in the art and from the figures, description and claims provided herein.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a system according to an embodiment of the present disclosure;

FIG. 2 is a login page according to an embodiment of the present disclosure;

FIG. 3 is a welcome page according to an embodiment of the present disclosure;

FIG. 4 is an automobile information form according to an embodiment of the present disclosure;

FIG. 5 is a user demographics form according to an embodiment of the present disclosure;

FIG. 6 is a consent form according to an embodiment of the present disclosure;

FIG. 7 is an affidavit of financial aid according to an embodiment of the present disclosure;

FIGS. 8 and 9 are report selection forms illustrating report criteria according to an embodiment of the present disclosure;

FIG. 10 is an age exception report according to an embodiment of the present disclosure.

### DETAILED DESCRIPTION

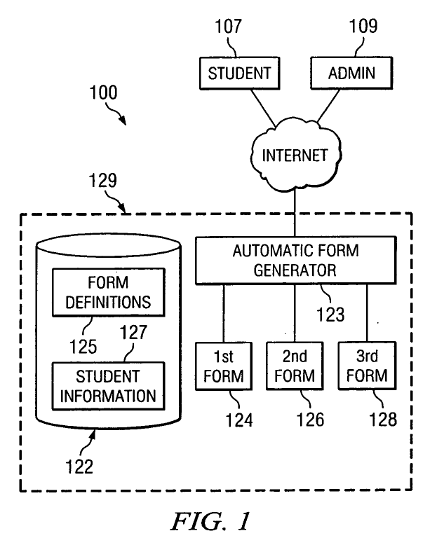

Preferred embodiments and their advantages are best understood by reference to FIGS. 1 through 11, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Various embodiments of the present disclosure may be implemented in one or more such information handling systems, or a network of information handling systems. In at least one embodiment, a website is provided that allows university officials to track compliance of student athletes with various university policies or requirements, conference policies or requirements, scholarship requirements, NCAA policies or other reporting requirements as deemed appropriate. Any such website may be maintained on a university information handling system or network of systems, hosted at a remote information system and made available to university officials and students using any of various internet or other network protocols, such as hypertext markup language (HTML), extensible markup language (XML) or the like. Data obtained from students via any of the web pages or forms presented through the website may be maintained by the university or by a third party as desired to comply with any of the various cost, security, management or other considerations deemed appropriate.

In considering the description of web pages, forms, etc., that follow, it should be noted that various changes can be implemented that change the appearance of a particular webpage, links on the webpage, and/or specific information presented in any particular field of a webpage. Furthermore, a webpage according to an embodiment of the present disclosure may include more or fewer web pages than those described below, in accordance with the teachings set forth herein. In at least one embodiment, the pages of a website according to the present disclosure may be branded to identify the pages and/or the website with a particular university or other educational facility. Such branding, and other changes to the appearance of any or all pages within the website, may be used to more closely match the web pages presented according to the present disclosure to web pages presented by a university's current website. In this way, a user navigating from a university's website to a website or particular web pages as disclosed herein, may be provided with a seamless transition.

Referring first to FIG. 1, a system 100 is illustrated according to an embodiment of the present disclosure. System 100 includes a student system 107 and an administrative system 109. Both student system 107 and administrative system 109 may be full-function information handling systems, “dumb-terminals” having minimal computational functionality, handheld systems, such as personal digital assistants (PDAs), mobile telephones, or any other suitable information handling systems.

Administrative system 109 and student system 107 are in communication with another information handling system, such as server 129. Server 129 may include any of various storage and processing subsystems commonly found in other servers, in addition to automatic form generator 123 and memory resource 122, including forms database 125 and student information database 127. In at least one embodiment, form generator 123 populates a form requested by a student or administrator with fields defined by forms definitions held in forms database 125, and fills in the fields using information from student information database 127. In the present preferred embodiment, such forms may comprise a first form 124 for obtaining information in compliance with university policies, a second form 126 for obtaining information in compliance with athletic conference policies and a third form 128 for obtaining information in compliance with national collegiate athletic organization. Generating forms automatically in this way permits the forms to be customized by school, student, administrator, or otherwise.

In a preferred embodiment, system 100 is used to implement a web-based information collection and report generation system useful for, among other things, tracking compliance of student athletes with various school, conference or agency or organization (such as the NCAA) reporting requirements. In a preferred embodiment, various web pages are presented as part of a website, as discussed below. In alternate embodiments, system 100 may be utilized for acquiring and managing student athlete recruiting information, athletic equipment information, academic compliance, alumni information, student athlete medical information, housing information, communications related information, and coaching information. In such alternate embodiments, automatic form generator 123 preferably generates electronic forms related to each subject, resulting data is then stored in storage resource 122.

The form generator 123 combines information from the form definitions 125 and the student information database 127 to derive a specific set of information elements related to the student athlete. An output template is selected for the ultimate output based on information in form definitions 125 and the user's role (student athlete, coach, administrator, etc.) The output template is preferably constructed in an HTML (hyper-text markup language), XML (extensible markup language), or other standardized format which includes specialized tags or instructions to form generator 123 as to how and where derived data elements are to be placed in the ultimate output form.

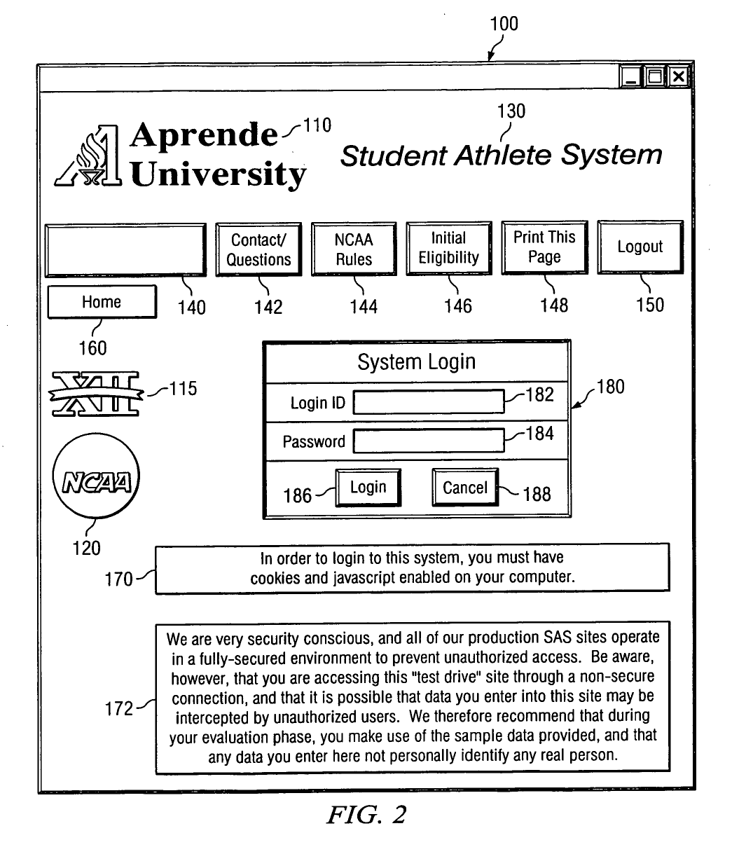

Referring next to FIG. 2, a login page 100 is presented according to an embodiment of the present disclosure. Objects displayed on a system login page may be similar to objects displayed on other pages. For example, a university logo 110 may be displayed along with various other organizational logos, such as Big 12 logo 115 and NCAA logo 120. It should be noted that these logos are not required in at least one embodiment, but may be used to assure users that the content displayed on various web pages is being used to help ensure compliance with any of the various organizations whose logo is used.

Login page 100 may also include Title 130 indicating that the login page and subsequent pages are being used as part of a student athlete system to help gather compliance or other information. A navigation bar 140 may be used to provide links to other pages that may contain useful information.

In FIG. 2, for example, links to a webpage providing contact information and frequently asked questions are provided by link 142. A link to NCAA rules is provided by link 144. Link 146 may be used to access initial eligibility criteria for student athletes. If a user wishes to print the login page, he may select the print this page icon 148 from navigation bar 140. A user may elect to log out of the system using logout object 150 included on navigation bar 140.

A second navigation bar 160 may also be provided to show other web pages within the student athlete system that are currently accessible to a user. In the illustrated example, a user is not yet logged in, so only the home page is accessible.

Descriptive text may be included in text boxes 170 and 172 to explain various procedures required of a user prior to system login, or to present various disclaimers or other similar information. System login box 180 includes data entry fields 182 and 184, in addition to login button 186 and cancel button 188, which allow a user to either login or cancel the login process, respectively.

It should be appreciated that although various terms such as link, button, navigation bar, and other terms commonly used with reference to Internet or distributed networks are used, various equivalents are known for each of these individual items, and any reference to one of these particular items should be understood to include such equivalents. For example, although login button 186 is displayed as a rectangular user-selectable button, any other suitable user selectable object may be used in its place. For example, a cartoon character, a picture of a lock, or any other suitable object may be displayed in place of or in addition to, the rectangular button.

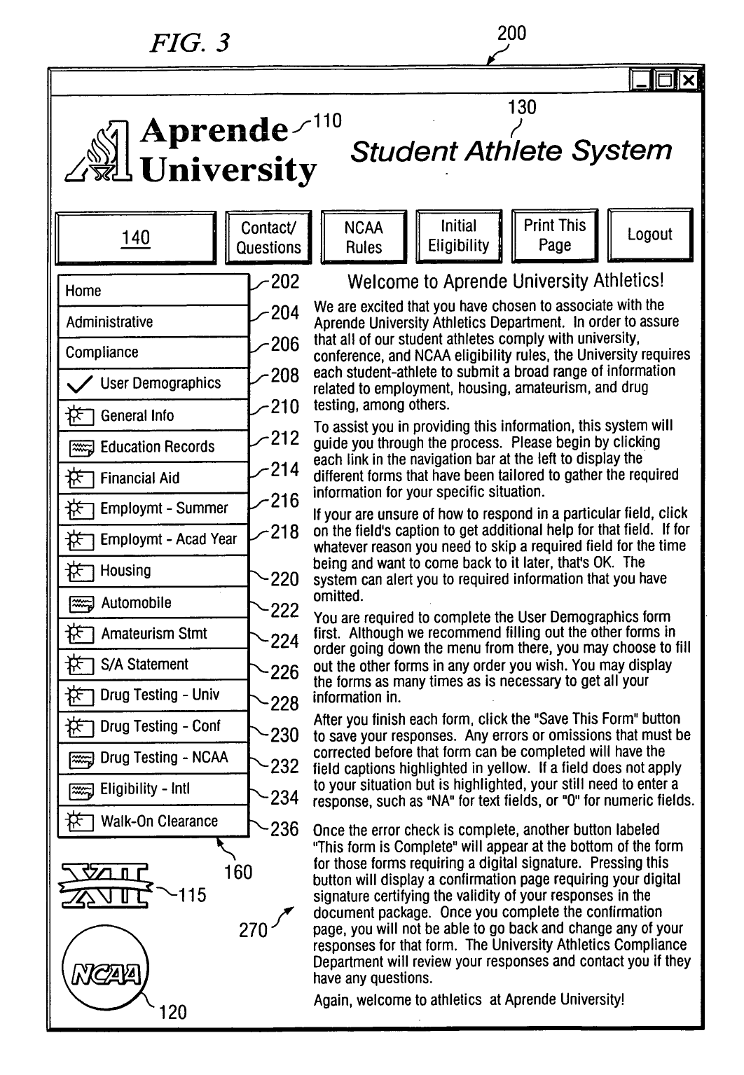

Referring next to FIG. 3, a welcome page is displayed according to an embodiment of the present disclosure. Welcome page 200 includes some of the same objects displayed on system login page 100. For example, university logo 100, Big 12 athlete conference logo 115 and NCAA logo 120 are all displayed on welcome page 200 in a manner similar to that in which they were displayed on system log-in page 100. Additionally, navigation bar 140, system title 130 and navigation bar 160 are also displayed on welcome page 200.

Note, however, that the contents of navigation bar 160 now includes administrative link 204 which may be used to link to a page usable by administrators or other school officials, as opposed to students generally. Navigation bar 160 may also include compliance link 206, which may be used to link to a page primarily designed for use by student athletes to enter information associated with entry of compliance information.

Note also that in FIG. 3, welcome page 200 includes links 208 through 236, which generally link to forms for use in entering compliance information such as user demographics, general information, education records, financial aid, summer employment, employment during an academic year, housing, automobile ownership or use, an amateurism statement, a student athlete statement, drug testing in compliance with university policies, conference policies and NCAA policies, initial eligibility, and walk-on clearance.

Whether compliance links 208 through 236 or administrative links (not specifically illustrated in FIG. 3) are shown on welcome page 200 may depend on the access rights of the user logging in through login page 100. The login ID and password used to gain access to the student athlete system, illustrated herein, can be linked to particular access rights that permit a user to access either administrative functions, data entry functions, or a selected combination thereof.

Other function types may be assigned to particular login IDs and password combinations. So, for example, a user having a particular login ID and password may be provided access only to data entry and affirmation (e.g. electronic signature) functions. Other users may have access to all or a subset of administrative functions. Yet other user types may be allowed access to administrative reporting functionality and compliance functions for entering data, but be restricted for performing authorizations, affirmations, etc.

Note that in many embodiments, once an affirmative statement has been entered into the data entry system, even users with full administrative access are not permitted to change the status of the affirmation. Although such administrative users may be allowed to provide an additional form which a student athlete may use to make an amended affirmation, in some embodiments an original affirmative statement made by a student athlete cannot be erased by an administrator.

Welcome page 200, like system login page 100, may include a text area 270 to provide desired information to a user.

Note that various symbols are included in certain user-selectable objects. For example, a check mark is displayed as part of user demographics link 208, a symbol representing a piece of paper with writing on it is displayed as part of education records link 212, automobile link 222, NCAA drug testing link 232 and initial eligibility link 234. The remaining links include an asterisk next to an envelope. As used herein, the check mark in user demographics link 208 indicates that the user has completed the user demographics form. The asterisk and the closed envelope in general info link 210, and other links, is used to indicate that the user has not yet started filling out the general information form linked to by general info link 210. The symbol representing a page with writing and a pencil in education records link 212, and other links, indicates that the user has started filling out the education records form but has not yet completed the form. In some embodiments a picture of a lock is used to indicate that a student athlete has completed a form and signed an affirmative statement. Other suitable symbol, picture, text, or the like may also be used.

By providing symbols next to link labels in navigation bar 160, a user can view the completion status of forms presented through the student athlete system 130. So, for example, once a student athlete logs into the system and is presented with welcome page 200, he or she can immediately look at navigation bar 160 to determine that user demographics information has already been entered. Likewise, it is easily apparent to the user that the general information form has not been completed.

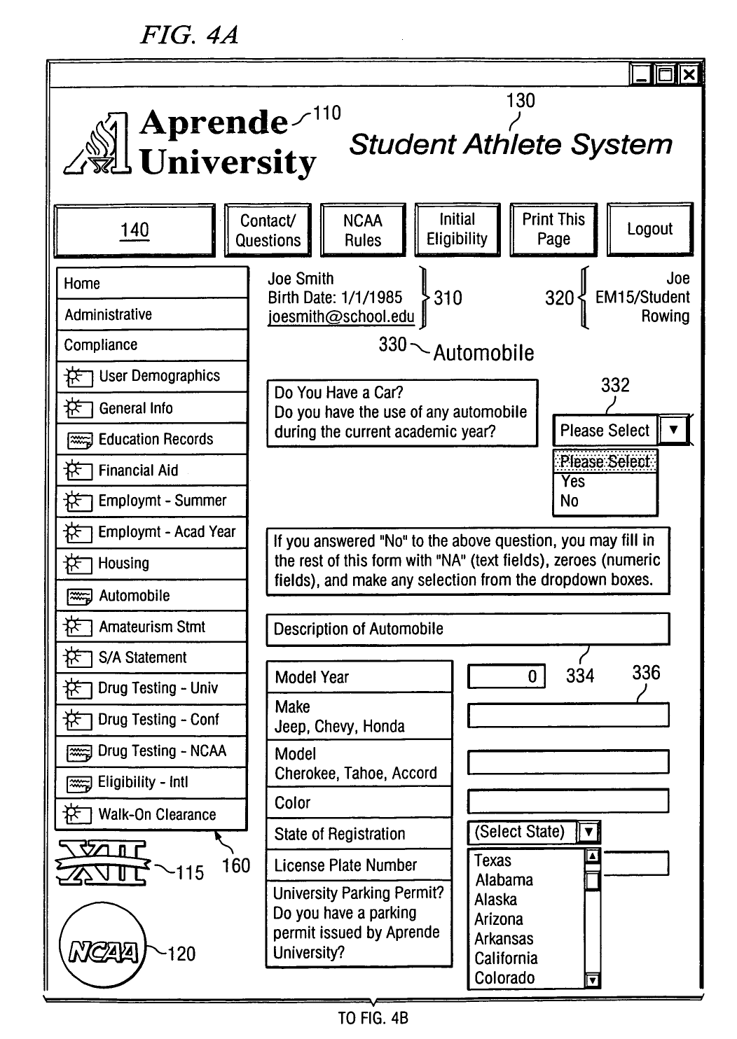

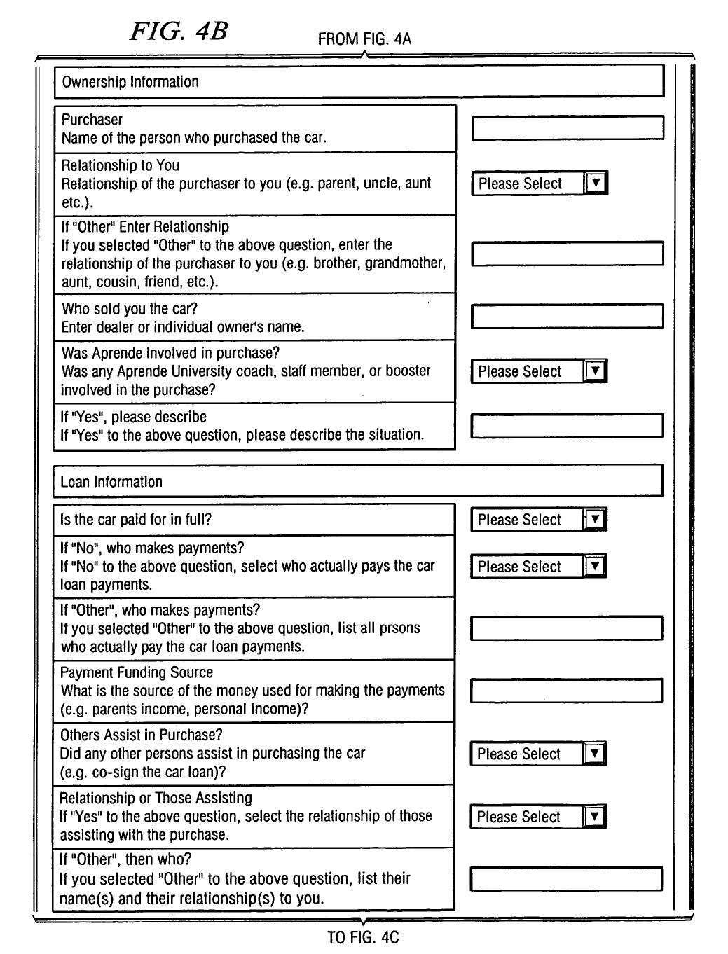

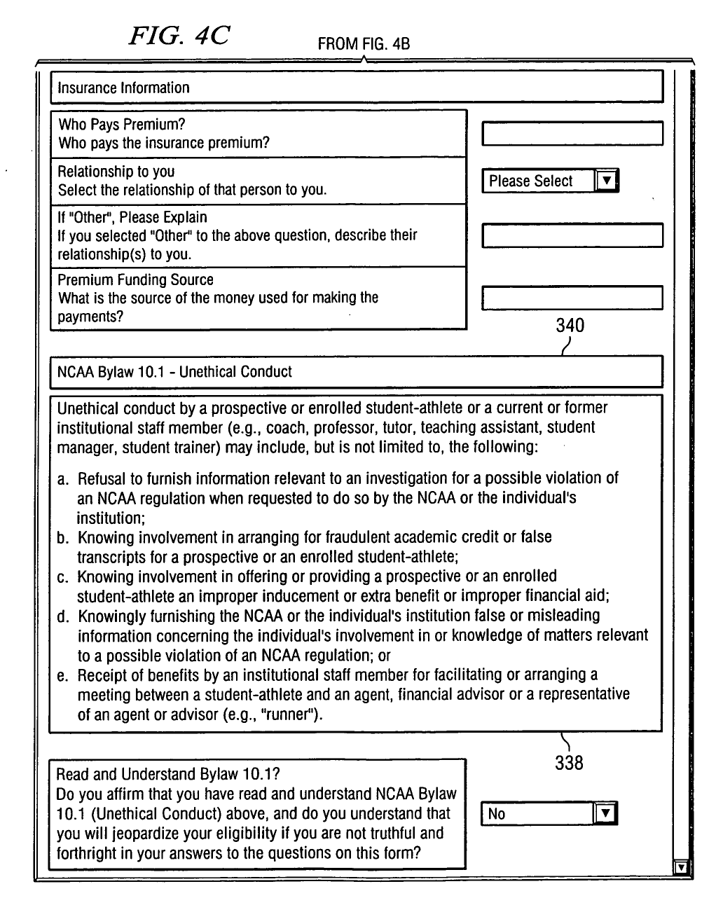

Referring next to FIG. 4, an example of an automobile information form is illustrated according to an embodiment of the present disclosure. Automobile form 300 includes school logo 110, Big 12 logo 115 and NCAA logo 120, along with the student athlete system title 130, navigation bar 140, and navigation bar 160. Automobile form 330 also includes form title 330 indicating the title of the form being displayed.

The user's name, birth date and email address may be displayed in user information area 310, while second information area 320 may be used to display a user name, a user type, and in the case of a student athlete, the sport in which the user is participating. In the illustrated case, information area 310 shows that the user Joe Smith was born on Jan. 1, 1985 and has an email address of joesmith@school.edu. Second information area 320 shows that Joe's user name is Joe, and that Joe is a student participating in rowing.

The automobile form may also include any of various types of fields in addition to or in place of those discussed. In general, the field types included in any of the forms are selected from the following field types: a text field, which may be the most common type of data entry field used to capture generic textual information; a date field that may contain numbers, slashes, periods and dashes; a number field that may contain only numbers, commas or a period; a drop-down list, which is a list of predefined values from which a user may select a desired value; an email address, which is a text field that should contain a valid email address including the at sign (“@”); a password field, which is a text field that displays only dots as the user's password is entered for security purposes; a check box field, which is used to record a users response to yes/no type questions; a radio button, which is used to permit the user to select one value from a list; a list of check boxes, which is used to permit a user to select multiple values from a list; a section heading, which is used to separate major sections of a form; display text, which are larger blocks of text used for user information or explanation on a form; and a text area that permits a user to enter large blocks of free form text.

The automobile form 300 presented in FIG. 4, illustrates many of these field types. For example, drop-down menu 332 is used to allow a student to select yes or no in response to the question “Do you have a car?” Description of automobile 334 is an example of a section heading. Field 336 is an example of a text entry field, where a user can enter the make of his automobile. A text block 338 under section heading 340 presents text related to the user's responsibility to properly fill-out the automobile form 300. Drop-down menu 342 provides the user with the ability to agree or disagree that he understands all of the above information and will adhere to the above statements regarding subsequent changes in information.

Some embodiments also include a display area 350 indicating the forms completion status, as well as the start date and the last edit date of the form.

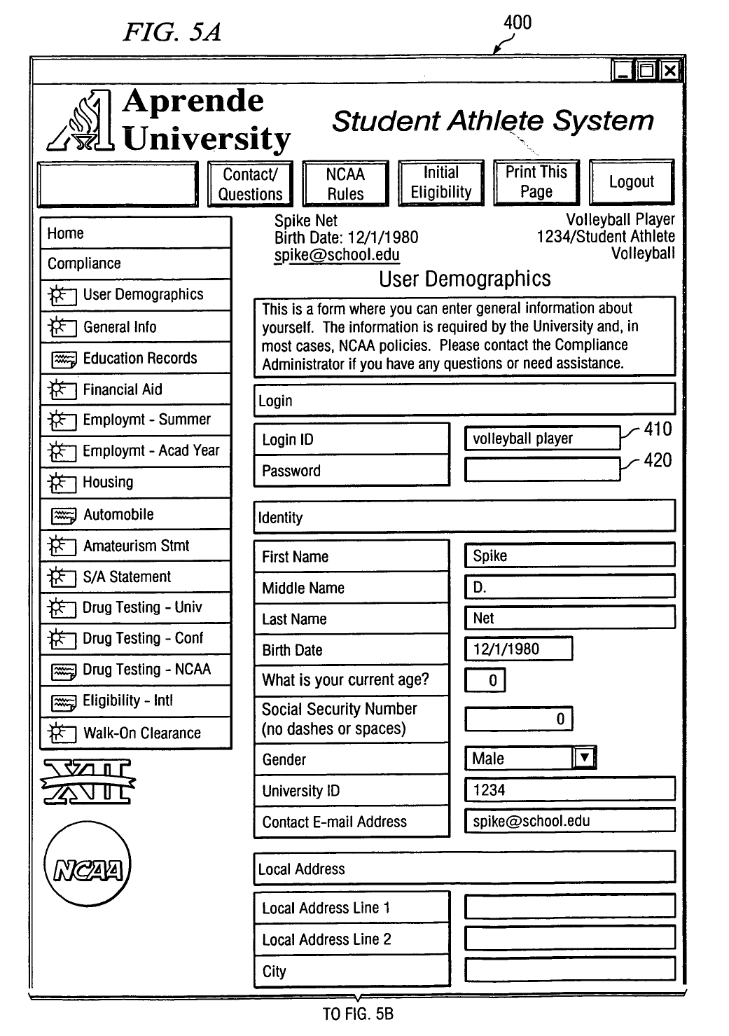

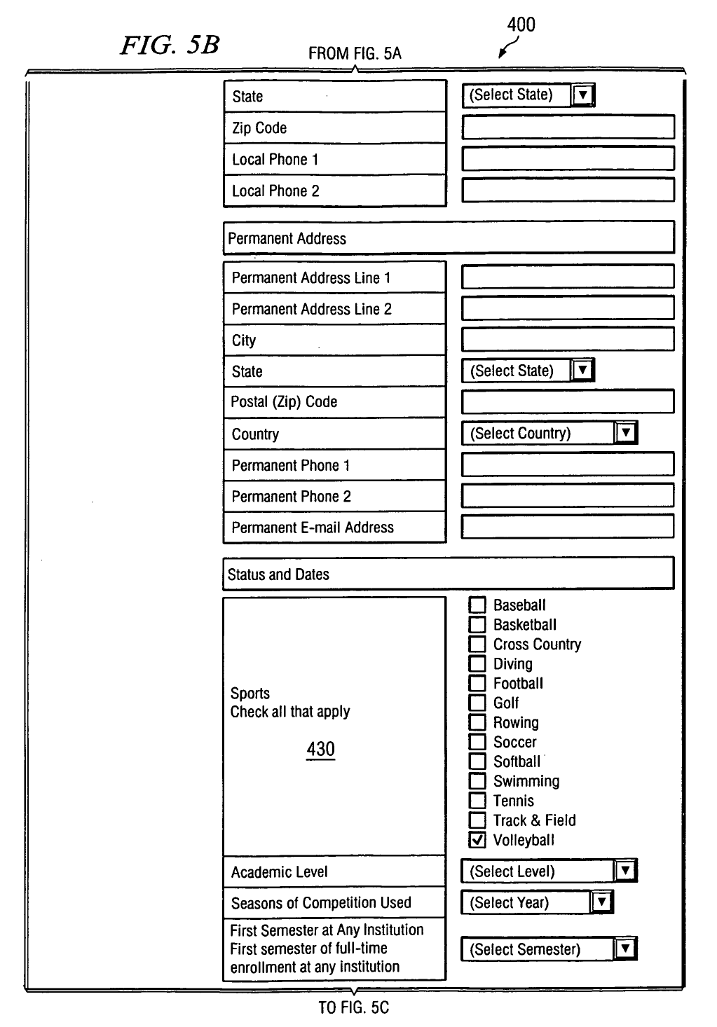

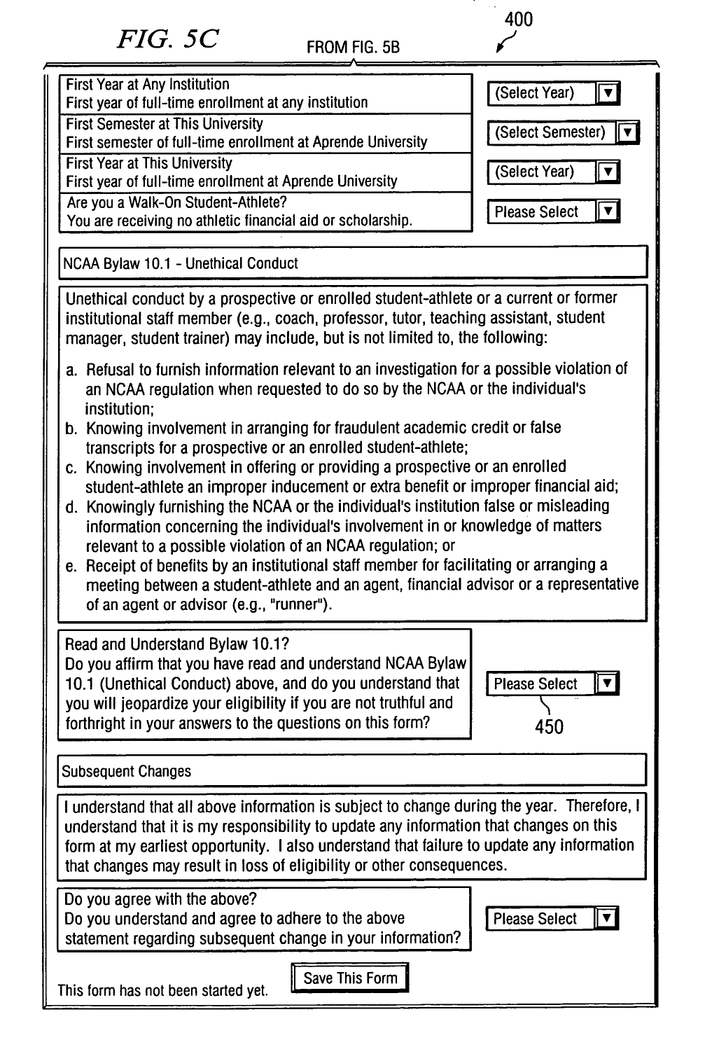

Referring next to FIG. 5, a user demographics form 400 will be discussed according to an embodiment of the present disclosure. Note that much of the same information is presented on user demographics form 400 as is presented on previously discussed forms, including various logos, titles and navigation bars.

User demographics form 400 includes text fields 410 and 420, which permit the user (SpikeNet) to change his login ID (volleyball player) and/or password. Other information on User Demographics form 400 includes name, social security number and other identifying information, local and permanent addresses, and the ability to indicate which sports the user is participating in. Note that in sports sections 430 an illustration of the list of check boxes entry field the user has selected only volley ball. If, however, the user were participating in more than one sport, multiple check boxes could be selected, indicating all of the sports in which SpikeNet was participating.

Drop-down menu 450 illustrates a field which is locked once save this form 452 is selected by the user, and cannot be changed by either the user or an administrator. So, for example, if a user saves form 400 after selecting Yes from dropdown menu 450, thereby indicating that they have read and understood by-law 10.1, drop-down menu 450 will be locked, and remain unchangeable in at least some embodiments. In other embodiments, an administrator having sufficient access rights may be permitted to reset a locked field, consistent with various school or other organizational policies.

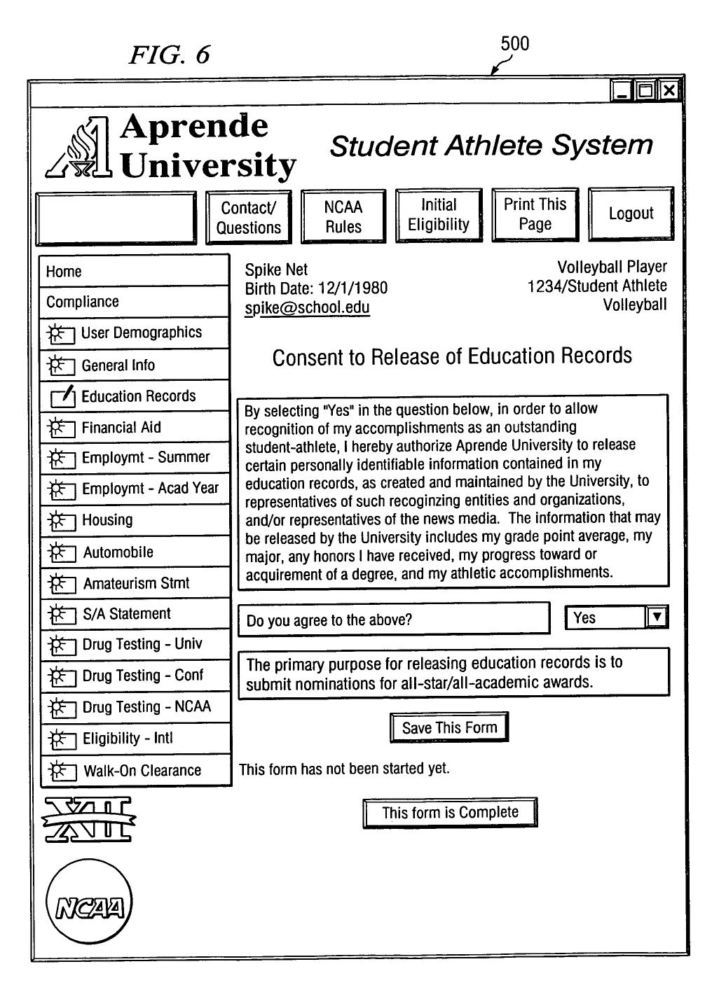

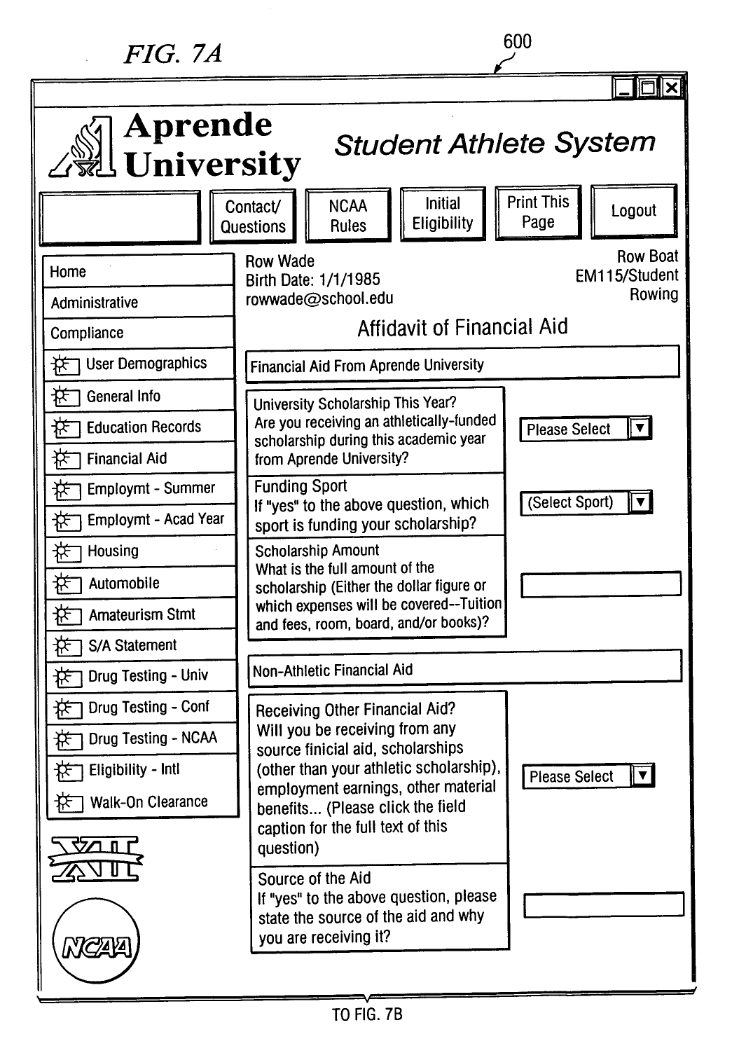

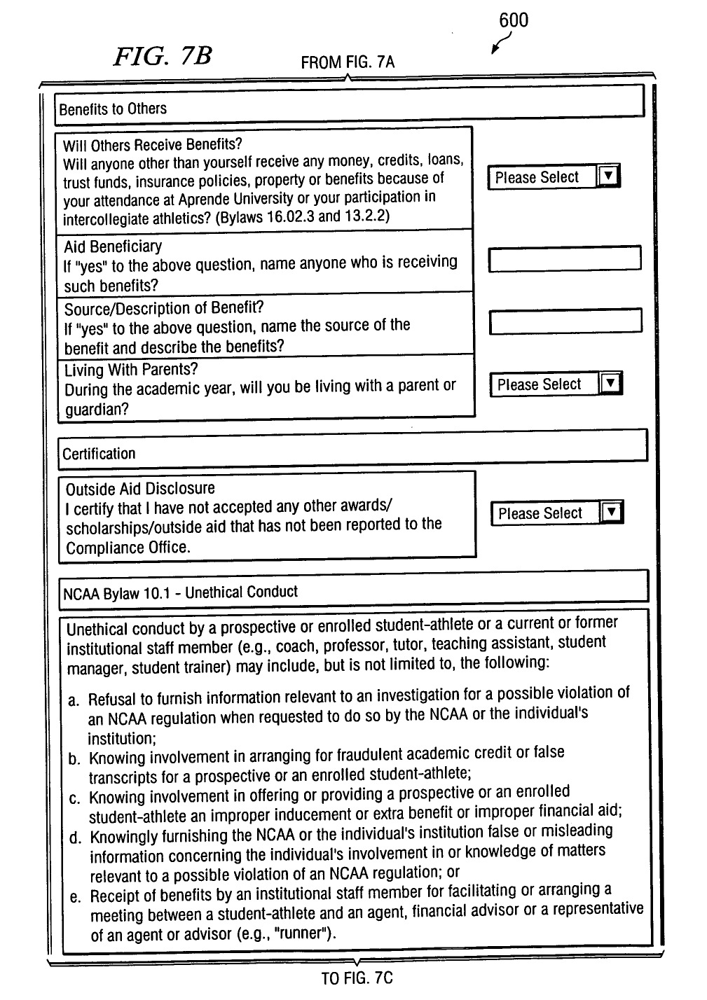

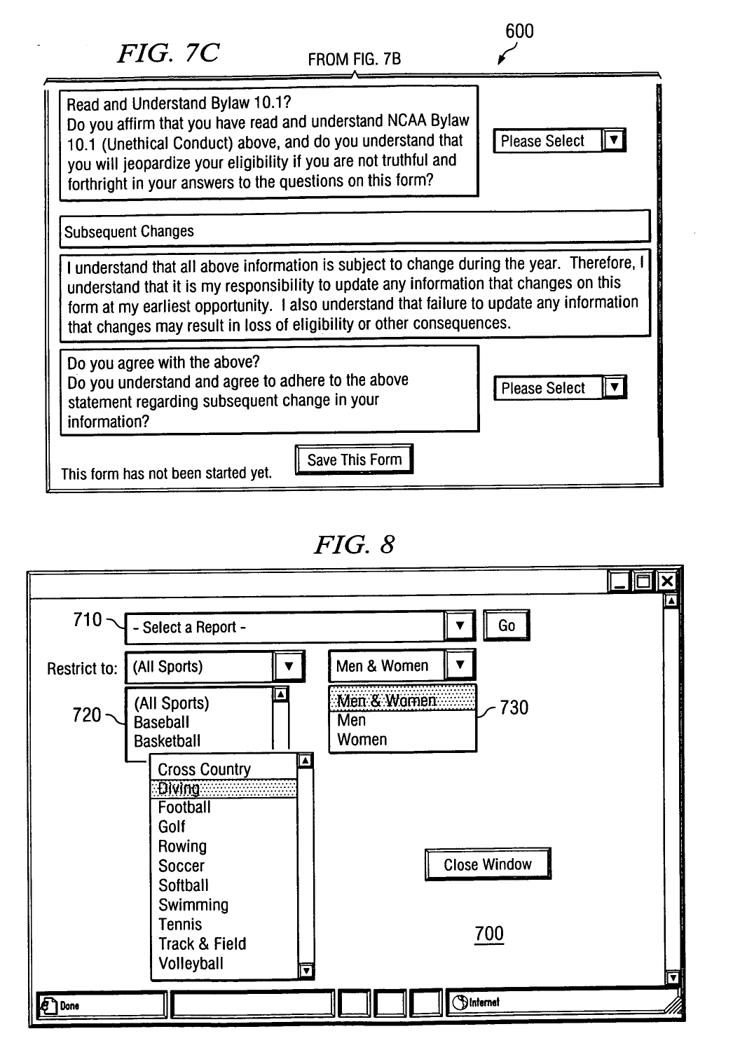

Referring next to FIG. 6, a consent to release of educational records form is illustrated according to an embodiment of the present disclosure. A consent form, such as form 500 is an example of a form that may be locked upon completion. Note that in FIG. 5, a particular field within a form was locked, however, upon completion of form 500 the entire form may be locked so that neither an administrator nor the student may subsequently alter the form. Another example of a form that may be locked according to various embodiments of the present disclosure is the affidavit of financial aid form 600, presented in FIG. 7.

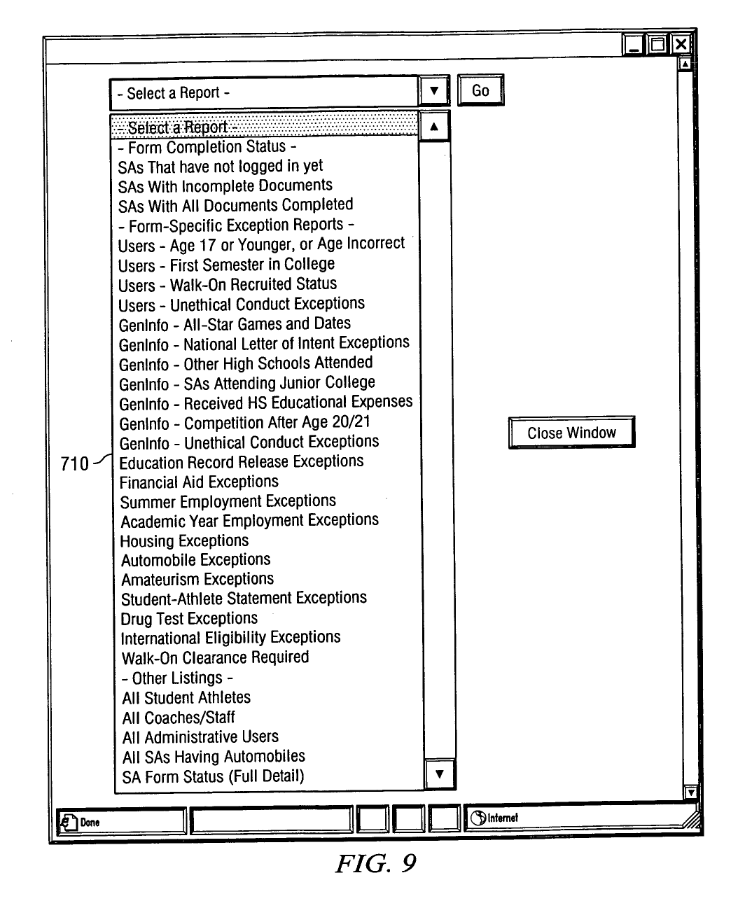

Referring next to FIGS. 8 and 9, a report selection page according to an embodiment of the present disclosure will be discussed. Report page 700 includes a report selection element 710, a restriction item 720, and a men's and women's selector 730. Using these three items, an administrative user or other person authorized to generate reports from information collected through the student athlete system forms discussed earlier, can select the desired report. As illustrated, items 720 and 730 may be implemented as drop-down menus.

Report selection element 710 is also illustrated as a drop-down menu in FIG. 8. It should be appreciated that the arrangement of items 710, 720, and 730 may be selected to permit all drop-down menus to be visible concurrently, or as in the illustrated embodiments of FIGS. 8 and 9, the drop-down menus may be arranged so that all or a portion of a particular drop-down menu obscures all or a portion of the remaining items. It should also be appreciated that although drop-down menus are illustrated as being used to select preconfigured reports, in other embodiments various other user selectable objects, text entry fields, or the like may be used to allow a user to select fields to include in a customized form.

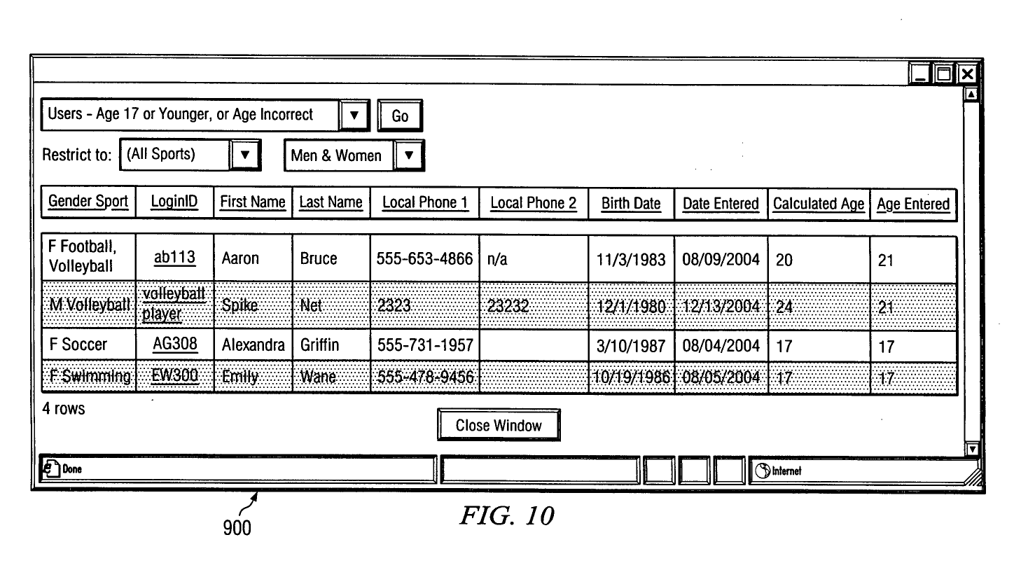

Referring next to FIG. 10, a report 900 is illustrated according to an embodiment of the present disclosure. Using the drop-down menus as illustrated in FIGS. 8 and 9, a user may generate a report identifying any students that are age 17 or younger, or whose age has been incorrectly entered into the data base. In the illustrated embodiment, there are no restrictions on the particular sport or the gender of the athlete, so report 900 reflects all student athletes in any sport whose age is incorrect or who is age 17 or younger.

Note that although particular information is illustrated in report 900, additional information, or less information, may be included in a particular report depending on the items addressed in the report. So, for example, if a report regarding amateurism exceptions for men's football is displayed, then the time and date of the amateurism exceptions, amounts received by the student athlete that caused the amateurism exception, or other information pertinent to the amateurism exception may be displayed.

In addition to the report contents, various options may be displayed on some or all of the report pages. So, for example, reports may be printed to hard copy, displayed on one or more web pages, displayed in various computer formats such as PDF, presented to the user in an email format, or otherwise as desired.

In various embodiments, data gathering and/or report generating forms are provided in a web page format that can be customized and tailored to a specific university's needs. So, for example, NCAA forms may be presented to student athletes in NCAA schools, along with any conference forms that may be applicable. Different forms can be presented to student athletes at schools, in different conferences, so that unnecessary forms will not be presented, and the student athlete can be presented with a highly customized and individualized data entry and maintenance form or other type of form. Various university specific forms can also be included as part or all of a form page presented to student athletes.

Given the highly variable nature of the forms, for example, each university or other educational institution may include its own set of forms and/or reports. It is generally desirable to avoid having to modify hard coded forms for each university because of the risk of coding mistakes that may be difficult to identify and correct. Additionally, code changes can be performed without the need for an experienced programmer to alter every form.

With these goals in mind, at least one embodiment of the present disclosure uses a set number of predefined field types including, but not limited to, text, date, email address, password, list of check boxes, and the other field types discussed earlier. It should be appreciated that other embodiments may use a subset of these field types, and some embodiments use field types other than those specifically discussed herein. Some embodiments, for example, provide for customized field types, or a variable number of field types.

In at least one embodiment, an SQL server available commercially through Microsoft or an equivalent, may be used to store data, form definitions, document status information, and the like. An active server page employing, for example, Microsoft Active Server Page Technology, permits access using an Internet browser, for example, Internet Explorer, Netscape, or the like, anywhere there is connectivity to the Internet.

This flexibility can be provided, in at least one embodiment, by maintaining an information database that includes information associated with each of the student athletes, in a forms database which includes information for customizing forms for a selected educational institution. So, when a student athlete, administrator, or other user links to a form customized for a particular university or educational institution, the requested web page includes a form dynamically generated based on a form template.

The form template may contain references to particular fields in a form database, and these fields may be customized for use by the particular school and for the user requesting the form. The information entered into the form by the user may be delivered to the information database for later use.

Although the disclosed embodiments have been described in detail, it should be understood that various changes, substitutions and alterations can be made to the embodiments without departing from their spirit and scope.

What is claimed is:

1. A method comprising:
maintaining an information database including compliance information associated with a plurality of student athletes;
maintaining a forms database comprising form definitions customized for compliance with policies of a selected educational institution, a selected athletic conference and a selected national collegiate athletic organization;
automatically generating a first form associated with a selected student athlete and customized for compliance with policies of the selected educational institution using a forms template and one or more form definitions obtained from the forms database;
automatically generating a second form associated with the selected student athlete and customized for compliance with policies of the selected athletic conference using the forms template and one or more form definitions obtained from the forms database;
automatically generating a third form associated with the selected student athlete and customized for compliance with policies of the selected national collegiate athletic organization and one or more form definitions obtained from the forms database; and
presenting the form to a user via a networked information handling system.

2. The method of claim 1, further comprising:
providing data entry fields on each form;
obtaining data entered into each form by one of the plurality of student athletes; and
updating the information database to include the data entered by the student athlete.

3. The method of claim 2, further comprising locking each form to prevent the entered data from being changed.

4. The method of claim 1, further comprising the forms configured for display by an Internet browser.

5. The method of claim 1, further comprising presenting a report-selection form to an authorized user via an Internet browser.

6. The method of claim 5, further comprising:
obtaining input from the authorized user indicating a selected report; and
providing the selected report to the authorized user.

7. The method of claim 1, wherein the presenting each form comprises presenting at least one data-entry forms associated with the student athlete to a user other than the student athlete.

8. The method of claim 1, wherein the presenting the form further comprises presenting at least one field type selected from the list consisting of: text, date, number, drop down list, email address, password, check box, radio button, list of check boxes, section heading, display text, and text area.

9. The method of claim 1, wherein automatically generating each form comprises generating a form comprising a plurality of user-selectable objects configured to display additional generated forms.

10. The method of claim 10, wherein the presenting the form further comprises displaying indicators associated with respective user-selectable objects, the indicators indicating whether forms associated with the respective user-selectable objects have been completed.

11. A computer readable medium tangibly embodying a program of executable instructions, said program of instructions comprising:
at least one instruction executable to maintain an information database comprising information associated with a plurality of student athletes;
at least one instruction executable to maintain a forms database comprising form definitions customized for a selected educational institution;
at least one instruction executable to automatically generate a first form associated with a selected student athlete and customized for compliance with policies of the selected educational institution using a forms template and one or more form definitions obtained from the forms database;
at least one instruction executable to automatically generate a second form associated with the selected student athlete and customized for compliance with policies of the selected athletic conference using the forms template and one or more form definitions obtained from the forms database;
at least one instruction executable to automatically generate a third form associated with the selected student athlete and customized for compliance with policies of the selected national collegiate athletic organization and one or more form definitions obtained from the forms database; and
at least one instruction executable to present the forms to a user via a networked information handling system.

12. The computer readable medium of claim 11, further comprising:
at least one instruction executable to provide data entry fields on each form;
at least one instruction executable to obtain data entered into each form by one of the plurality of student athletes; and
at least one instruction executable to update the information database to include the data entered by the student athlete.

13. The computer readable medium of claim 11, further comprising at least one instruction executable to lock each form to prevent the entered data from being changed.

14. The computer readable medium of claim 11, wherein at least one instruction executable to generate each form configured for display by an Internet browser.

15. The computer readable medium of claim 11, wherein the at least one instruction executable to present the form comprises at least one instruction executable to present a report-selection form to an authorized user via an Internet browser.

16. The computer readable medium of claim 15, further comprising:
at least one instruction executable to obtain input from the authorized user indicating a selected report; and
at least one instruction executable to provide the selected report to the authorized user.

17. The computer readable medium of claim 11, wherein the at least one instruction executable to present the form comprises at least one instruction executable to present one of a plurality of data-entry forms associated with the student athlete to a user other than the student athlete.

18. The computer readable medium of claim 11, wherein the at least one instruction executable to present the form further comprises at least one instruction executable to present one or more field types selected from the list consisting of: text, date, number, drop down list, email address, password, check box, radio button, list of check boxes, section heading, display text, and text area.

19. The computer readable medium of claim 11, wherein the at least one instruction executable to automatically generate the form comprises at least one instruction executable to generate a form comprising a plurality of user-selectable objects configured to display additional automatically generated forms.

20. The computer readable medium of claim 19, wherein the at least one instruction executable to present each form further comprises at least one instruction executable to display indicators associated with respective user-selectable objects, the indicators indicating whether forms associated with the respective user-selectable objects have been completed.

21. A system comprising:
at least one processor;
at least one memory operably accessible to said at least one processor, said at least one memory storing:
an information database comprising information associated with a plurality of student athletes;
a forms database comprising form definitions customized for compliance with policies of a selected educational institution, a selected athletic conference and a selected national collegiate athletic organization; and
a forms template;
a communications subsystem capable of coupling said system to a communications network; and
a program of instructions capable of being stored in said memory and executed by said at least one processor, said program of instructions comprising:
at least one instruction executable to automatically generate a first form associated with a selected student athlete and customized for compliance with policies of the selected educational institution using a forms template and one or more form definitions obtained from the forms database;
at least one instruction executable to automatically generate a second form associated with the selected student athlete and customized for compliance with policies of the selected athletic conference using the forms template and one or more form definitions obtained from the forms database;
at least one instruction executable to automatically generate a third form associated with the selected student athlete and customized for compliance with policies of the selected national collegiate athletic organization and one or more form definitions obtained from the forms database; and
at least one instruction executable to present the forms to a user via a remote information handling system coupled to the information handling system via the communications subsystem.

22. The information handling system of claim 21, wherein the program of instructions further comprises:
at least one instruction executable to obtain data entered into each form by the selected student athlete; and
at least one instruction executable to update the information database to include the data entered by the student athlete.

23. The information handling system of claim 21, wherein the program of instructions comprises at least one instruction executable to generate each form configured for display by an Internet browser.

24. The information handling system of claim 21, wherein the program of instructions comprises:
at least one instruction executable to present a report-selection form to an authorized user via an Internet browser;
at least one instruction executable to obtain input from the authorized user indicating a selected report; and
at least one instruction executable to provide the selected report to the authorized user.

25. The information handling system of claim 21, wherein the program of instructions comprises at least one instruction executable to generate a form comprising a plurality of user-selectable objects configured to display additional dynamically generated forms.
